(19) United States
(12) Patent Application Publication
(10) Pub. No.: US 2010/0158346 A1
(43) Pub. Date: Jun. 24, 2010

(54) METHOD AND SYSTEM OF CLASSIFYING DEFECTS ON A WAFER

(76) Inventors: Wei FANG, Milpitas, CA (US); Zhao-Li Zhang, San Jose, CA (US); Jack Jau, Los Altos Hills, CA (US)

Correspondence Address: Muncy, Geissler, Olds & Lowe, PLLC, 4000 Legato Road, Suite 310, FAIRFAX, VA, 22033, US

(21) Appl. No.: 12/343,201

(22) Filed: Dec. 23, 2008

(51) Int. Cl. G06K 9/00

(52) U.S. Cl. 382/149

(57) ABSTRACT

Method of classifying the defects on a wafer having some same chips and corresponding system. After receiving images formed by scanning the wafer using a charged particle beam, these images are examined such that both defective images and defect-free images are found. Then, the defect-free images are translated into a simulated layout of the chip, or a database is used to provide the simulated layout of the chip. Finally, the defects on the defective images are classified by comparing the images with the simulated layout of the chip. The system has some modules separately corresponds to the steps of the method.

### FIELD OF THE INVENTION

The invention relates to a method and a system of classifying defects, especially a method and a system of classifying defects by a simulated layout.

### BACKGROUND OF THE INVENTION

After a wafer is scanned by a charged particle beam, there are numerous scanned images respectively corresponds to numerous chips of the wafer. Clearly, some scammed images are defect-free images when the corresponding chips have no defect, and other scanned images are defective images when each corresponds chip has at least one defect.

There are some known arts to find which scanned image is detective image and to find which portion(s) of the detective image corresponds to the defect(s). For example, die-to-die, die-to-database, and array mode. However, almost all these known arts achieve the results by comparing the scanned images corresponding to the same chip. Hence, these known arts only can find which portion(s) of which chip corresponds to defect(s), but can not find what kind of the defect(s) is (at least can not find what semiconductor structure corresponds to the defect(s)). In short, it cannot identify a defect from a lead, a MOS or an electrode under the situation of lacking the layout of the chip. Even the defect feature is important for improving the manufacturing process.

### SUMMARY OF THE INVENTION

Method and system to classify the defects by using a simulated layout. The simulated layout corresponds to the real layout of the chips to be scanned. Hence, when the accuracy of the simulation is high enough, the defects on the scanned images could be properly classified according to what portions of the simulated layout corresponds to the defects on the scanned images.

The simulated layout can be achieved by some known arts, such as manual drawing layout based image and/or converting image into vector based on auto edge tracing. Moreover, the simulated layout also can be achieved by any known, on-developing or new appeared arts, the invention never restricts the details.

The proposed method may be programmed and merged to the system of scanning electron microscope (SEM).

Method of classifying the defects on a wafer. The method includes receiving images formed by a charged particle beam, examining images to find the defective images and defect-free images, translating the defect-free images into a simulated layout of a chip and classifying the defects on the defective images by comparing the images with the simulated layout of the chip. Herein, the step of translating the defect-free image into the layout may be omitted as the simulation thereof exists.

System of classifying the defects on a wafer. The system has different modules separately corresponds to different steps of the above present method.

### BRIEF DESCRIPTION OF THE DRAWINGS

FIG. 1 is an exemplary method for translating images into a simulated layout according to an embodiment of the present invention.

FIG. 2 is an exemplary method for illustrating a process of classifying defects of same chips on a wafer according to an embodiment of the present invention.

FIG. 3 is another exemplary method for illustrating the process of classifying defects of same chips on a wafer according to an embodiment of the present invention.

FIG. 4 is an exemplary system for classifying defects of same chips on a wafer according to an embodiment of the present invention.

### DESCRIPTION OF THE EXEMPLARY EMBODIMENTS

It is easy to find defects of a chip on a wafer, there are some well-know skills to find the positions of the defects. But, it is difficult to classify the defect type in absence of the chip layout as it is necessary to compare the image of the chips with the real layout to identify the features of the defects. As usual, only the IC-design house has the real layout but the factory does not have the real layout, even it is helpful that the factory can immediately analyze and classify the defects for improving the manufacture of the IC chips However, for current semiconductor industry, the yield of manufacturing semiconductors can be increased beyond 99%, so most chips on a wafer are defect-free and only few of the chips are defective, so it is easy to identify the defective images and the defect-free images. By translating the defect-free images into a simulated layout, and then comparing the defective image with the simulated layout, the defect feature may be automatically classified based on the messages about what semiconductor structure corresponds by the defects.

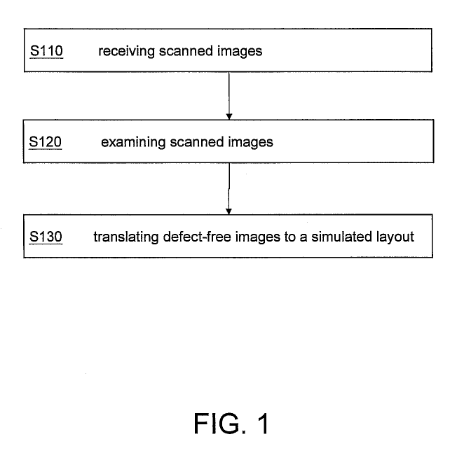

FIG. 1 is an exemplary method of the present invention for illustrating a process of translating images into a simulated layout. As illustrated in FIG. 1, at step S110, images of same chips on a wafer formed by scanning the wafer using a charged particle system are received. Next, at step S120, the images are examined to find the defect-free images. Next, at step S130, the defect-free images are translated into a simulated layout. Herein, step 110 could be achieved by using the conventional SEM, and step 120 could be achieved by many well-known skills, such as did-to-die and array mode. Herein, step 130 could be achieved by using some known skill, such as manual drawing layout based image and converting image into vector based on auto edge tracing. Indeed, all steps 110/120/130 also could be achieved by any on-developing and new skills. One key of the embodiment is the combination of the three steps 110/120/130, but not the details of each step 110/120/130.

Once getting the simulated layout, the corresponding relationship between a scanned image and the simulated layout can be known, such that what kind of semiconductor structure (such as line, via, gate, drain etc) is located on the position corresponds to a defect on the scanned image. Therefore, the defects can be classified according to what kind of semiconductor structure is corresponded.

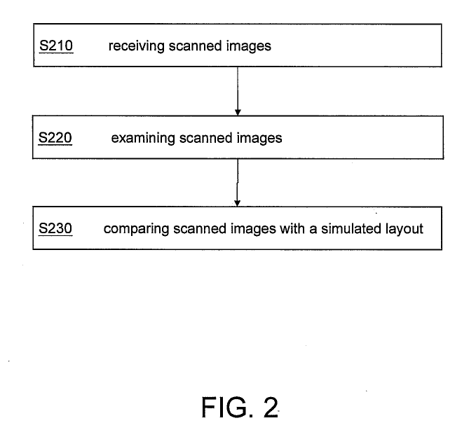

FIG. 2 is an exemplary method for classifying defects of same chips on a wafer according to an embodiment of the present invention. As illustrated in FIG. 2, at step S210, images of the same chips on a wafer formed by scanning the wafer using a charged particle system is received. Next, at step S220, the images are examined to find the defective images corresponding to the defective chips. Next, at step S230, the defective images are compared with a simulated layout of such chip to classify the defect feature of the defective chips.

Clearly, FIG. 2 is an application of FIG. 1. Because there are many wafers having the same chips, when these chips are mass products. Hence, once at least one wafer is examined by the method shown in FIG. 1, a useful simulated layout of such chip could be achieved. Then, when examine other wafers having the same chips, it is simple to directly use the existent simulated layout but not find a new simulated layout for a new wafer again.

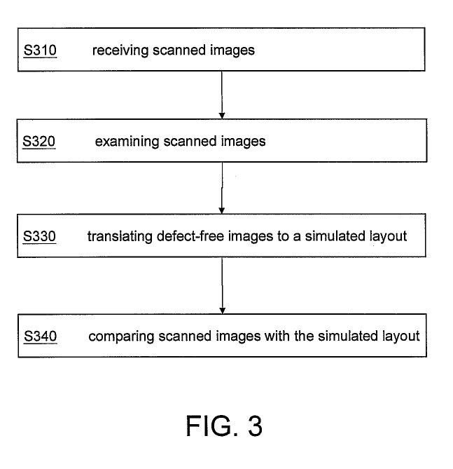

FIG. 3 is another exemplary method for classifying defects of same chips on a wafer according to an embodiment of the present invention, which includes integrating the process of translating a simulated layout and classifying the defect type. As illustrated in FIG. 3, at step S310, images of same chips on a wafer formed by scanning the wafer using a charged particle beam system are received. Next, at step S320, the images are examined to recognize the defective and defect-free images of the same chips respectively corresponding to the defective chips and defect-free chips. Next, at step S330, the defect-free images are translated into a simulated layout. Next, at step S340, the defect feature of defective chips is classified by comparing the defective images with the simulated layout.

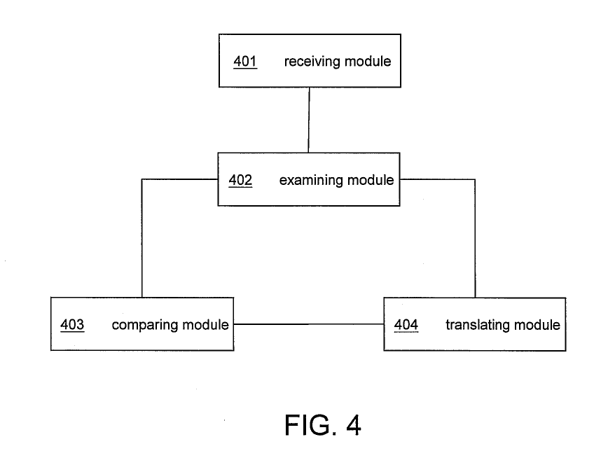

FIG. 4 is an exemplary system for classifying defects of same chips on a wafer according to an embodiment of the present invention. The system comprises a receiving module 401, an examining module 402 and a comparing module 403. The receiving module 401 could receive some images acquired by a charged particle beam, wherein the images respectively correspond to some chips having similar feature on an examined wafer (if no defect and/or no tolerance, they should have same feature). The examining module 402 could examine the images to find at least a defective image that has at least one defect feature corresponding to a defect on a chip. The comparing module 403 could compare the defective image with a simulated layout corresponding to a real layout of the chips to classify the defect(s) on the chip. Of course, beside the simulated layout is existed before the operation of the proposed system, the system further comprises a translating module 404 for translating a defect-free image into the simulated layout, wherein the effect-free image is found by examining the image.

The comparing module 403 maps a location of the defect feature into a mapped location of the simulated layout. Then, by checking what kind of semiconductor structure is located on the mapped location, it is easy to classify the defect. For example, the defect is classified as a hole defect when a hole located on the mapped location, the defect is classified as a line defect when the mapped location corresponds to a line between chips, and the defect is classified as an omissible defect when the mapped location corresponds to neither a semiconductor structure nor a conductive structure around said semiconductor structure. Herein, as an example, the semiconductor could be a MOS, a capacitor, a doped region, an inductor, and so on, and the conductive structure could be a metal line, a plug, and so on.

It should be noted that the details of each module 401/402/403/404 is not restricted. All well-known, on-developing and to be appeared skills could be used to achieve these modules. For example, the receiving module 401 and the examining module 402 could be achieved by the well-known apparatus for performing the die-to-die or array module. The function of the comparing module 403 essentially is comparing two figures and finding the message of a specific portion of a figure, it is a well-known image analysis operation and then there are many well-known apparatus could be used. The translating module 404 also could be achieved by any apparatus capable of translating an image object to a vector object, such as a computer with a software for converting image into vector based on auto edge tracing.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method of classifying defects on a wafer, comprising:
receiving a plurality of images acquired by a charged particle beam, wherein said images respectively correspond to a plurality of chips having similar feature on an examined wafer;
examining said images, such that at least a defect-free image and at least a defective image are found, wherein said defective image includes at least one defect feature corresponding to a defect on said chip;
translating said defect-free image into a simulated layout that corresponds to a real layout of said chips; and
comparing said defective image with said simulated layout to classify said defect on said chip.

2. The method as claimed in claim 1, further comprising a step of using said simulated layout to classify defects on another wafer having a plurality of similar chips.

3. The method as claimed in claim 1, wherein said step of examining said images is chosen from a group consisting of the following: die-to-die, array mode and a combination thereof.

4. The method as claimed in claim 1, wherein said step of translating said defect-free image is chosen from a group consisting of the following: manual drawing layout based image, convert image into vector based on auto edge tracing and a combination thereof.

5. The method as claimed in claim 1, wherein said step of comparing said defective image with said simulated layout includes mapping location of said defect feature into a mapped location of said simulated layout such that said defect is classified based on a structure located on said mapped location.

6. The method as claimed in claim 5, wherein said defect is classified as a hole defect when a hole is located on said mapped location, wherein said defect is classified as a line defect when said mapped location corresponds to a line between chips, and wherein said defect is classified as an omissible defect when said mapped location corresponds to neither a semiconductor structure nor a conductive line around said semiconductor structure.

7. A method of classifying defects on a wafer, comprising:
receiving a plurality of images acquired by a charged particle beam, wherein said images respectively correspond to a plurality of chips having similar feature on an examined wafer;
examining said images, such that at least a defective image is found, wherein said defective image includes at least one defect feature corresponding a defect on a said chip; and
comparing said defective image with a simulated layout that corresponds to a real layout of said chips to classify said defect on said chip.

8. The method as claimed in claim 7, wherein said simulated layout is acquired by the following steps:
receiving a plurality of additional images respectively corresponding to a plurality of similar chips;
examining said additional images, such that at least a defect-free additional image is found; and
translating said defect-free image into said simulated layout.

9. The method as claimed in claim 8, wherein said additional images are chosen from a group consisting of the following: said images on said examined wafer, a plurality of images on a wafer examined before said examined wafer, and combination thereof.

10. The method as claimed in claim 7, wherein said step of examining said additional images is chosen from a group consisting of the following: die-to-die, array mode and a combination thereof.

11. The method as claimed in claim 7, wherein said translating step is chosen from a group consisting of the following: manual drawing layout based image or converting image into vector based on auto edge tracing.

12. The method as claimed in claim 7, wherein said step of comparing said defective image with a simulated layout includes mapping a location of said defect feature into a mapped location of said simulated layout such that said defect is classified according to a structure located on said mapped location.

13. The method as claimed in claim 12, wherein said defect is classified as a hole defect when a hole located on said mapped location, wherein said defect is classified as a line defect when said mapped location corresponds to a line between chips, and wherein said defect is classified as an omissible defect when said mapped location corresponds to neither a semiconductor structure nor a conductive structure around said semiconductor structure.

14. A system for classifying defects on a wafer, comprising:
a receiving module for receiving a plurality of images acquired by a charged particle beam, wherein said images respectively correspond to a plurality of chips having similar feature on an examined wafer;
an examining module for examining said images to find at least a defective image that has at least one defect feature corresponding to a defect on a said chip; and
a comparing module for comparing said defective image with a simulated layout corresponding to a real layout of said chips to classify said defect on said chip.

15. The system as claimed in claim 14, further comprising a translating module for translating a defect-free image into said simulated layout, wherein said effect-free image is found by examining said images.

16. The system as claimed in claim 14, wherein said examination module examine said images by using a method chosen from a group consisting of the following: die-to-die, die-to-database, array mode and a combination thereof.

17. The system as claimed in claim 14, wherein said translating module translates said defect-free chip by using a method chosen from a group consisting of the following: manual drawing layout based image or converting image into vector based on auto edge tracing.

18. The system as claimed in claim 14, wherein said comparing module maps a location of said defect feature into a mapped location of said simulated layout such that said defect is classified based on a structure located on said mapped location.

19. The system as claimed in claim 15, wherein said defect is classified as a hole defect when a hole located on said mapped location, wherein said defect is classified as a line defect when said mapped location corresponds to a line between chips, and wherein said defect is classified as an omissible defect when said mapped location corresponds to neither a semiconductor structure nor a conductive structure around said semiconductor structure.
